(19) United States
(12) Patent Application Publication
(10) Pub. No.: US 2025/0065816 A1
(43) Pub. Date: Feb. 27, 2025

(54) Dual-Shaft Dual-Screen Roof-Mounted Vehicle Display

(71) Applicant: Jet Optoelectronics Co., Ltd., Taipei City (TW)

(72) Inventors: Ke-Yu Tsai, New Taipei City (TW); Sheng-Yueh Lin, Taipei City (TW)

(21) Appl. No.: 18/607,914

(22) Filed: Mar. 18, 2024

(30) Foreign Application Priority Data
Aug. 24, 2023 (TW) 112131939

(51) Int. Cl. B60R 11/02; B60R 11/00

(52) U.S. Cl. CPC B60R 11/0229; B60R 2011/0028; B60R 2011/0082

(57) ABSTRACT

A dual-shaft dual-screen roof-mounted vehicle display is provided. The dual-shaft dual-screen roof-mounted display has a roof mount, a first display, a second display, a first rotating shaft, and a second rotating shaft. The first display is connected to the roof mount and the second display via the first rotating shaft and the second rotating shaft respectively, and the first display and the second display may be retracted through the first rotating shaft and the second rotating shaft, improving the functionality of the roof-mounted display.

### CROSS-REFERENCE TO RELATED APPLICATION

This application claims priority from Taiwan Patent Application No. 112131939, filed on Aug. 24, 2023, in the Taiwan Intellectual Property Office, the content of which is hereby incorporated by reference in its entirety for all purposes.

### BACKGROUND OF THE INVENTION

### 1. Field of the Invention

The present disclosure relates to a roof-mounted vehicle display, particularly to a roof-mounted vehicle display having dual shafts and dual screens.

### 2. Description of the Related Art

With the advancement of technology and the demand of human beings for audio-visual entertainment, all kinds of display-related audio-visual equipment have been widely used in homes, companies, public places, medium and large-sized vehicles, airplanes, cruise ships, etc. During the commute to work or long-distance travel, to pass a long period of boredom on the transportation system, there already have been entertainment devices to entertain passengers, such as stereos or displays. These devices are provided for passengers to listen to music or watch movies, etc., in order to pass the time when taking the transportation.

However, the conventional roof-mounted vehicle display nowadays only has a single rotating shaft, which has a higher viewing angle when used. Passengers in the rear seat need to raise their heads for viewing. Viewing with heads raised for a long time causes shoulder and neck pain, resulting in a poor user experience. In addition, since the conventional roof-mounted vehicle display only comes with a single screen, when a user needs to switch viewing modes or operate the user interface, it is necessary to jump out of the viewing screen before doing so, leading to a poor viewing experience.

In summary, there is a need to develop a roof-mounted vehicle display that solves the issue that one needs to raise his or her head and improves the viewing experience, in order to solve the aforementioned problems.

### SUMMARY OF THE INVENTION

Given the aforementioned conventional problems, the present disclosure provides a roof-mounted vehicle display that comes with dual shafts and dual screens to improve the user experience for rear-seat passengers.

To achieve the aforementioned purpose, the present disclosure provides a dual-shaft dual-screen roof-mounted vehicle display, including a roof mount, a first display, a second display, a first rotating shaft, and a second rotating shaft. The first display may be movably connected to the roof mount through the first rotating shaft and movably connected to the second display through the second rotating shaft, wherein the first rotating shaft and the second rotating shaft are respectively disposed on a top and a bottom of the first display.

Wherein, the first display may be retracted to the roof mount through the first rotating shaft, so that the first display is parallel to the roof mount; the second display may be retracted to the roof mount through the second rotating shaft to be parallel to the roof mount and the first display, thus retracting both the first display and the second display to the roof mount. When the dual-shaft dual-screen roof-mounted vehicle display is to be used, the second display may be flipped so that the second display is expanded from the roof mount, and the first display is expanded from the roof mount simultaneously through an interconnecting movement of the first rotating shaft and the second rotating shaft, in order to watch videos or have online video conferences; after use, the second display likewise may be flipped so that the first display is retracted to the roof mount simultaneously through an interconnecting movement of the first rotating shaft and the second rotating shaft, in order to complete the retraction.

The first display is used as a secondary screen and the second display is used as a primary screen, so the size of the first display is smaller than that of the second display. With the use of the dual-shaft design of the first rotating shaft and the second rotating shaft, when the first display and the second display are expanded, the second display when expanded to the viewing position may be positioned lower than the conventional roof-mounted vehicle display through the height occupied by the first display when expanded. This allows rear-seat passengers to look at the screen without raising their heads when watching videos, thus solving the problem of shoulder and neck pain experienced by rear-seat passengers.

In addition, since the first display is used as a secondary screen, the function of switching viewing modes or the user interface may be moved thereon, so passengers in the rear seat may perform operations without having to jump out of the viewing screen when watching videos, reducing the need to switch viewing modes or go back and forth in the user interface. Furthermore, when the rear-seat passenger needs to conduct an online meeting during his or her commute to work and when the meeting is in progress, the first display may show additional information, such as meeting presentations or stock market information. This makes it easier for people to be informed of relevant information readily during a meeting without having to present it on a single screen in a segmented view, thus enhancing work efficiency.

Preferably, the roof mount may be further disposed with an illuminating lamp, and the illuminating lamp is disposed between the roof mount and the first display, so that the illuminating lamp may illuminate between the rear-seat passenger and the two displays after the first display and the second display are expanded, thus compensating for the poor lighting in the interior of the vehicle at night and enhancing the viewing experience.

Preferably, the roof mount may be further disposed with an LED ambient light, and the LED ambient light is disposed around the roof mount and a vehicle roof, which makes different lighting effect changes according to usage scenarios, thus enhancing the user experience. For example, the color or brightness of music may be changed while playing, or lighting effects may be made corresponding to the sound effects of videos while viewing.

The technical features of the present disclosure are to be illustrated in detail below with specific embodiments and accompanying drawings to make a person with ordinary skill in the art effortlessly understand the purposes, technical features, and advantages of the present disclosure.

### BRIEF DESCRIPTION OF THE DRAWINGS

The exemplary embodiments of the present disclosure are to be more fully understood from the following detailed description and the accompanying drawings of various embodiments of the present disclosure, which, however, should not be regarded as limiting the present disclosure to particular embodiments, but are only used for illustrative and understanding purposes only.

FIG. 1 is a schematic diagram of the dual-shaft dual-screen roof-mounted vehicle display according to the present disclosure;

FIG. 2 is a side view of the dual-shaft dual-screen roof-mounted vehicle display according to the present disclosure;

FIG. 3 is a schematic diagram of the expanding process of the dual-shaft dual-screen roof-mounted vehicle display according to the present disclosure;

FIG. 4 is a schematic diagram of the dual-shaft dual-screen roof-mounted vehicle display according to the present disclosure, which is further disposed with an illuminating lamp on the roof mount;

FIG. 5 is a schematic diagram of the dual-shaft dual-screen roof-mounted vehicle display according to the present disclosure, which is further disposed with an LED ambient light on the roof mount.

### DESCRIPTION OF THE PREFERRED EMBODIMENTS

To make the features, contents, and advantages as well as the effects achieved by the present disclosure clearly expressed, the present disclosure is to be described in detail in conjunction with the form of the accompanying drawings. In addition, the drawings herein are used only to indicate and support the specification, which is not necessarily the real proportion and precise configuration after the implementation of the present disclosure. Therefore, the relations of the proportion and configuration of the attached drawings should not be interpreted to limit the actual scope of implementation of the present disclosure.

To make a more complete and clearer disclosure of the technical contents, the purpose of the present disclosure, and the effects achieved by the present disclosure, they are described in detail below. Please refer to the disclosed drawings and drawing numbers together.

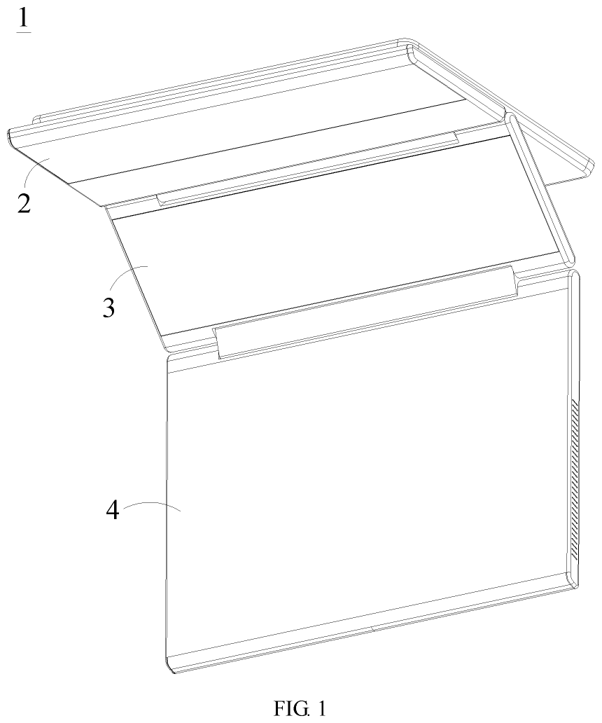

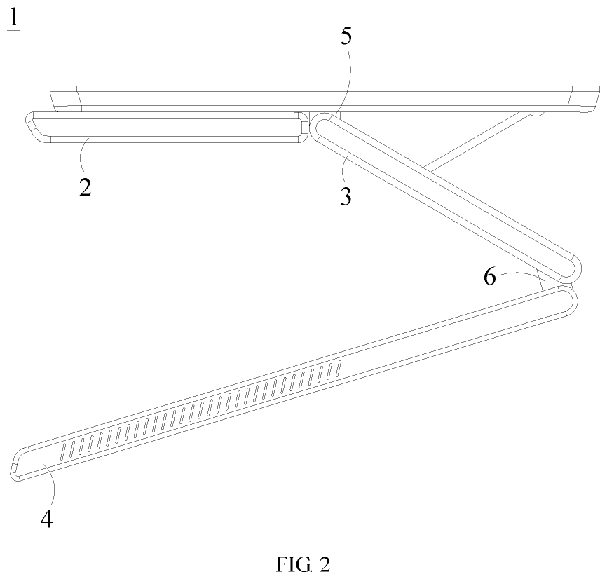

Please refer to FIG. 1 and FIG. 2, which respectively are a schematic diagram and a side view of the dual-shaft dual-screen roof-mounted vehicle display according to the present disclosure.

The dual-shaft dual-screen roof-mounted vehicle display 1 includes a roof mount 2, a first display 3, a second display 4, a first rotating shaft 5, and a second rotating shaft 6; the first display 3 may be movably connected to the roof mount 2 through the first rotating shaft 5 and movably connected to the second display 4 through the second rotating shaft 6, wherein the first rotating shaft 5 and the second rotating shaft 6 are respectively disposed on a top and a bottom of the first display 3.

Wherein, the first display 3 may be retracted to the roof mount 2 through the first rotating shaft 5, so that the first display 3 is parallel to the roof mount 2; the second display 4 may be retracted to the roof mount 2 through the second rotating shaft 6 to be parallel to the roof mount 2 and the first display 3, thus retracting both the first display 3 and the second display 4 to the roof mount 2.

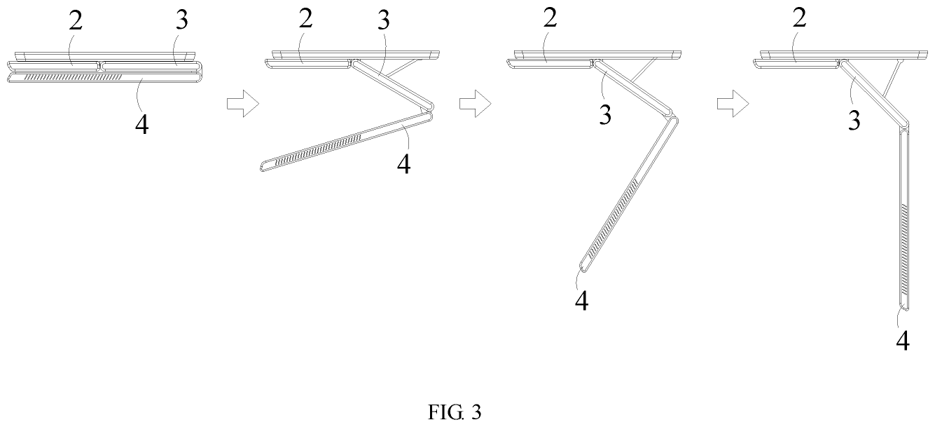

Please also refer to FIG. 3, which is a schematic diagram of the expanding process of the dual-shaft dual-screen roof-mounted vehicle display according to the present disclosure. When the dual-shaft dual-screen roof-mounted vehicle display 1 is to be used, the second display 4 may be flipped so that the second display is expanded from the roof mount 2, and the first display 3 is expanded from the roof mount 2 simultaneously through an interconnecting movement of the first rotating shaft 5 and the second rotating shaft 6, in order to watch videos or have online video conferences; after use, the second display 4 likewise may be flopped so that the first display 3 is retracted to the roof mount 2 simultaneously through an interconnecting movement of the first rotating shaft 5 and the second rotating shaft 6, in order to complete the retraction.

The first display 3 is used as a secondary screen and the second display 4 is used as a primary screen, so the size of the first display 3 is smaller than that of the second display 4. With the use of the dual-shaft design of the first rotating shaft 5 and the second rotating shaft 6, when the first display 3 and the second display 4 are expanded, the second display 4 when expanded to the viewing position may be positioned lower than the conventional roof-mounted vehicle display through the height occupied by the first display 3 when expanded. This allows rear-seat passengers to look at the screen without raising their heads when watching videos, thus solving the problem of shoulder and neck pain experienced by rear-seat passengers.

In addition, since the first display 3 is used as a secondary screen, the function of switching viewing modes or the user interface may be moved thereon, so passengers in the rear seat may perform operations without having to escape from the viewing screen when watching videos, reducing the need to switch viewing modes or go back and forth in the user interface. Furthermore, when the rear-seat passenger needs to conduct an online meeting during his or her commute to work and when the meeting is in progress, the first display 3 may show additional information, such as meeting presentations or stock market information. This makes it easier for people to be informed of relevant information readily during a meeting without having to present it on a single screen in a segmented view, thus enhancing work efficiency.

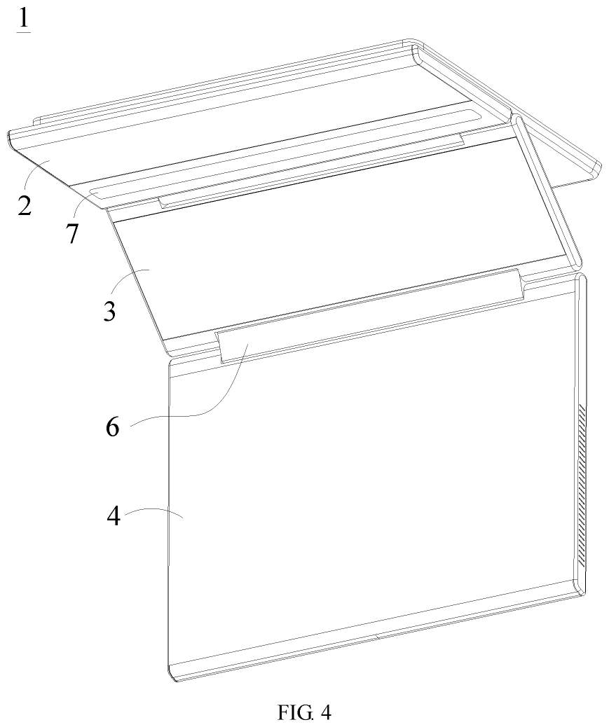

Please also refer to FIG. 4, which is a schematic diagram of the dual-shaft dual-screen roof-mounted vehicle display according to the present disclosure, which is further disposed with an illuminating lamp on the roof mount. Preferably, the roof mount 2 may be further disposed with an illuminating lamp 7, and the illuminating lamp 7 is disposed between the roof mount 2 and the first display 3, so that the illuminating lamp May 7 illuminate between the rear-seat passenger and the two displays after the first display 3 and the second display 4 are expanded, thus compensating for the poor lighting in the interior of the vehicle at night and enhancing the viewing experience.

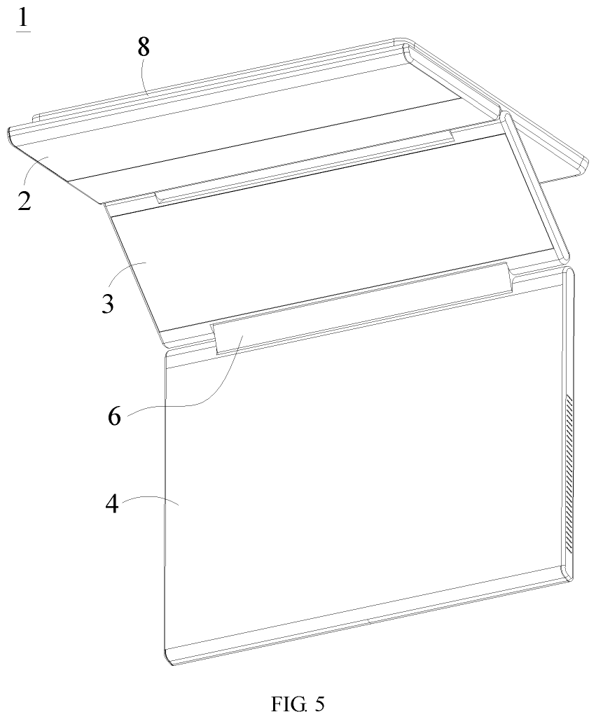

Finally, please refer to FIG. 5, which is a schematic diagram of the dual-shaft dual-screen roof-mounted vehicle display according to the present disclosure, which is further disposed with an LED ambient light on the roof mount. Preferably, the roof mount 2 may be further disposed with an LED ambient light 8, and the LED ambient light 8 is disposed around the roof mount 2 and a vehicle roof, which makes different lighting effect changes according to usage scenarios, thus enhancing the user experience. For example, the color or brightness of music may be changed while playing, or lighting effects may be made corresponding to the sound effects of videos while viewing.

To sum up, through the dual-shaft dual-screen roof-mounted vehicle display provided by the present disclosure, it is possible to solve the problem that the height of the conventional roof-mounted vehicle display is too high, which forces the rear-seat passengers to raise their heads to look at the screen, resulting in soreness and pain in the shoulder and neck. Furthermore, the viewing experience may be improved by using the other screen as a secondary screen, and additional information may be displayed to enhance the user experience.

The embodiments of the present disclosure covered by the patent application are defined by the present claims, not by the summary of the invention. The summary of the invention is a high-level generalization of the various aspects of the present disclosure and introduces some concepts further described in the following detailed description. The summary of the invention is not intended to identify the essential or necessary features of the claimed subject matter, nor is it intended to be used solely to define the claimed subject matter. The subject matter should be understood by reference to the entire specification, any or all of the drawings, and the appropriate portion of every claim of the present disclosure.

What is claimed is:

1. A dual-shaft dual-screen roof-mounted vehicle display, comprising
a roof mount;
a first display, movably connected to the roof mount through a first rotating shaft; and
a second display, movably connected to the first display through a second rotating shaft, wherein
the first rotating shaft and the second rotating shaft are respectively disposed on a top and a bottom of the first display.

2. The dual-shaft dual-screen roof-mounted vehicle display for vehicle according to claim 1, wherein the first display is configured to be retracted to the roof mount through the first rotating shaft, so that the first display is parallel to the roof mount.

3. The dual-shaft dual-screen roof-mounted vehicle display according to claim 2, wherein the second display is configured to be retracted to the roof mount through the second rotating shaft to be parallel to the roof mount and the first display.

4. The dual-shaft dual-screen roof-mounted vehicle display according to claim 1, wherein a size of the first display is smaller than that of the second display.

5. The dual-shaft dual-screen roof-mounted vehicle display according to claim 2, wherein a size of the first display is smaller than that of the second display.

6. The dual-shaft dual-screen roof-mounted vehicle display according to claim 3, wherein a size of the first display is smaller than that of the second display.

7. The dual-shaft dual-screen roof-mounted vehicle display according to claim 1, wherein the roof mount is further disposed with an illuminating lamp, and the illuminating lamp is disposed between the roof mount and the first display.

8. The dual-shaft dual-screen roof-mounted vehicle display according to claim 1, wherein the roof mount is further disposed with an LED ambient light, and the LED ambient light is disposed around the roof mount and a vehicle roof.

9. The dual-shaft dual-screen roof-mounted vehicle display according to claim 1, wherein when the dual-shaft dual-screen roof-mounted vehicle display is to be used, the second display is configured to be flipped so that the second display is expanded from the roof mount, and the first display is expanded from the roof mount simultaneously through an interconnecting movement of the first rotating shaft and the second rotating shaft.

10. The dual-shaft dual-screen roof-mounted vehicle display according to claim 9, wherein after the first display and the second display are expanded, a height of the second display is lowered by a height occupied by an expansion of the first display.

11. The dual-shaft dual-screen roof-mounted vehicle display according to claim 1, wherein when the dual-shaft dual-screen roof-mounted vehicle display is to be stored, the second display is configured to be flipped so that the first display is retracted to the roof mount simultaneously through an interconnecting movement of the first rotating shaft and the second rotating shaft.
